(19) United States
(12) Patent Application Publication
(10) Pub. No.: US 2010/0279611 A1
(43) Pub. Date: Nov. 4, 2010

(54) WIRELESS COMMUNICATION TERMINAL AND TERMINAL RECOGNIZING METHOD

(75) Inventor: Masayuki Kumazawa, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/810,287

(22) PCT Filed: Dec. 24, 2008
(86) PCT No.: PCT/JP2008/003932

§ 371 Date: Jun. 23, 2010

(30) Foreign Application Priority Data
Dec. 28, 2007 (JP) 2007-339912

(51) Int. Cl. H04B 7/00

(52) U.S. Cl. 455/41.2

(57) ABSTRACT

Wireless communication terminals whereby it is possible for users who are acquainted with one another to recognize that the users are approaching one another without revealing private information to a third party. Each of the wireless communication terminals comprises a local-terminal identifying information storing part (202) that stores local-terminal identifying information that is information for identifying the terminal itself; an other-terminal identifying information storing part (203) that stores other-terminal identifying information that is information for identifying another terminal; a mutual identification information generating part (204) that generates, from the local-terminal identifying information and other-terminal identifying information, first mutual identification information by use of a predetermined algorithm; an identifying information transmitting/receiving part (205) that wirelessly receives second mutual identification information from the other terminal; and a determining part (206) that determines whether the second mutual identification information received by the information transmitting/receiving part (205) and the first mutual identification information generated by the mutually-identifying information generating part (204) match.

### TECHNICAL FIELD

The present invention relates to a wireless communication terminal that performs communication using a wireless technique and a terminal recognizing method for recognizing other terminals from the wireless communication terminal.

### BACKGROUND ART

Conventionally, short-range wireless interfaces such as Bluetooth (registered trademark) and wireless LAN (local area network) have been used mainly for communication between a portable terminal and peripheral devices and Internet communication via a wireless access point or the like. However, short-range wireless interfaces are being increasingly mounted on various portable terminals such as mobile phone set and FDA (personal digital assistant) in recent years and direct short-range wireless communication between portable terminals is being performed more actively.

A technique of supporting communication between users by reporting an approach between the users using short-range wireless communication between portable terminals is described, for example, in Patent Document 1.

FIG. 1 is a flowchart illustrating the operation of a wireless communication terminal described in Patent Document 1.

As shown in FIG. 1, when communication such as telephone conversation or exchange of e-mails is performed (S11), a wireless communication terminal saves a communication history including identification information of another terminal, which is the other party of communication (S12). The wireless communication terminal then searches other terminals (hereinafter “other terminals”) existing within a short-distance range, that is, a range within which communication is possible, using a short-range wireless communication interface (S13). When another terminal exists within the short-distance range (S14: “YES”), the wireless communication terminal establishes a communication link with the other terminal (S15) and the terminals mutually refer to communication histories stored in the respective terminals (S16). As a result, when a communication history of the other party is checked (S17: “YES”), the wireless communication terminal reports the communication history to a user (S18).

When, for example, the user comes closer to an acquaintance in the street, the user can know that the acquaintance is approaching as a result of recognition of the approach between the wireless communication terminals. That is, the wireless communication terminal disclosed in Patent Document 1 is able to support active communication among users by recognizing the approach among the terminals using short-range wireless communication.

### Patent Document 1: Japanese Patent Publication No. 3942593

### DISCLOSURE OF INVENTION

### Problems to be Solved by the Invention

However, a problem with the wireless communication terminal disclosed in Patent Document 1 is that it is necessary to disclose identification information about the wireless communication terminal (terminal possessed by the user) and other terminals included in the communication history to the other terminal about which the user is not sure if the other terminal belongs to an acquaintance. This is not desirable from the standpoint of protecting privacy and securing security. Especially, it is possible that a malicious third party repeats the processing shown in FIG. 1 on the wireless communication terminal only for the purpose of acquiring communication histories of other users.

Therefore, it is desirable to allow wireless communication terminals to recognize each other's approach only when the users are acquainted with each other without disclosing privacy-related information such as identification information of a wireless communication terminal and identification information of other terminals of acquaintances to a third party.

It is therefore an object of the present invention to provide a wireless communication terminal and a terminal recognizing method capable of recognizing a mutual approach only when users are acquainted with each other without disclosing privacy-related information to a third party.

### Means for Solving the Problem

The wireless communication terminal of the present invention adopts a configuration including: a self-identification information storage section that stores self-identification information comprising identification information of the wireless communication terminal; another identification information storage section that stores other identification information comprising identification information of another terminal other than the wireless communication terminal; a mutual identification information generation section that generates first mutual identification information from the self-identification information and the other identification information using a predetermined algorithm; an identification information receiving section that receives by wireless second mutual identification information from the other terminal; and a determination section that determines whether or not the first mutual identification information generated by the mutual identification information generation section and the second mutual identification information received by the identification information receiving section match.

The wireless communication terminal of the present invention adopts a configuration including: a self-identification information storage section that stores identification information of the wireless communication terminal; another identification information storage section that stores identification information of another terminal; a mutual identification information generation section that generates mutual identification information from the identification information of the wireless communication terminal and the identification information of the other terminal using a predetermined algorithm; and an identification information transmitting section that transmits by wireless the mutual identification information generated by the mutual identification information generation section to the other terminal.

The wireless communication terminal of the present invention adopts a configuration including: a self-identification information storage section that stores self-identification information comprising identification information of the wireless communication terminal; another identification information storage section that stores other identification information comprising identification information of another terminal other than the wireless communication terminal; a mutual identification information generation section that generates first mutual identification information from the self-identification information and the other identification information using a predetermined algorithm; an identification information transmitting/receiving section that receives by wireless second mutual identification information from the other terminal and transmits by wireless the first mutual identification information generated by the mutual identification information generation section to the other terminal; and a determination section that determines whether or not the first mutual identification information generated by the mutual identification information generation section and the second mutual identification information received by the identification information transmitting/receiving section match.

The terminal recognizing method of the present invention includes steps of: generating first mutual identification information from own terminal identification information comprising identification information of a terminal and other identification information comprising identification information of another terminal other than the terminal using a predetermined algorithm; storing the first mutual identification information generated in a storage means; receiving by wireless second mutual identification information from the other terminal; searching in the storage means the first mutual identification information that matches the received second mutual identification information; and a step of determining, when the first mutual identification information that matches the received second mutual identification information exists in the storage means, that a transmission source of the second mutual identification information is the other terminal indicated by the other identification information that is a basis of the first mutual identification information.

The terminal recognizing method of the present invention includes steps of: receiving by wireless first mutual identification information from another terminal other than a terminal; generating second mutual identification information from own terminal identification information comprising identification information of the terminal and other identification information comprising identification information of the other terminal using a predetermined algorithm; determining whether or not the received first mutual identification information and the generated second mutual identification information match; and determining, when the received first mutual identification information and the generated second mutual identification information match, that a transmission source of the first mutual identification information is the other terminal indicated by the other identification information that is a basis of the second mutual identification information.

### ADVANTAGEOUS EFFECTS OF INVENTION

According to the present invention, mutual identification information transmitted by a wireless communication terminal is not privacy-related information but can be associated with identification information of transmission source by the receiving side terminal only when both the transmitting-side terminal and receiving-side terminal store counterpart identification information. Therefore, it is possible to recognize a mutual approach only when users are acquainted with each other without disclosing privacy-related information to a third party.

### BRIEF DESCRIPTION OF DRAWINGS

FIG. 1 is a flowchart showing the operation of a conventional wireless communication terminal;

FIG. 2 is a block diagram of a communication network system having wireless communication terminals according to an embodiment of the present invention;

FIG. 3 is a block diagram showing a configuration of the wireless communication terminal according to the present embodiment;

FIG. 4 shows contents of an identification information table of a first wireless communication terminal according to the present embodiment;

FIG. 5 shows contents of an identification information table according to the present embodiment;

FIG. 6 shows contents of an identification information table of a third wireless communication terminal according to the present embodiment;

FIG. 7 shows a configuration of an identification frame according to the present embodiment;

FIG. 8 shows a configuration of an identification frame that stores a report type according to the present embodiment;

FIG. 9 shows contents of a related identification information table of the first wireless communication terminal according to the present embodiment;

FIG. 10 is a flowchart illustrating the overall operation of the wireless communication terminal according to the present embodiment;

FIG. 11 is a flowchart showing mutual identification information reception processing according to the present embodiment;

FIG. 12 is a flowchart showing mutual identification information generation processing according to the present embodiment;

FIG. 13 is a flowchart showing approach reporting and recording processing according to the present embodiment;

FIG. 14 is a flowchart showing mutual identification information transmission processing according to the present embodiment;

FIG. 15 shows an example of a communication sequence in the communication system of the present embodiment;

FIG. 16 illustrates a configuration of an approach reporting system according to Example 1 of the present embodiment;

FIG. 17 shows an example of a communication sequence in the approach reporting system shown in FIG. 16;

FIG. 18 illustrates a configuration of a communication system according to Example 2 of the present embodiment;

FIG. 19 is a flowchart showing an example of the operation of the first terminal in the communication system shown in FIG. 18; and

FIG. 20 illustrates an example of a lifelog display screen according to Example 2 of the present embodiment.

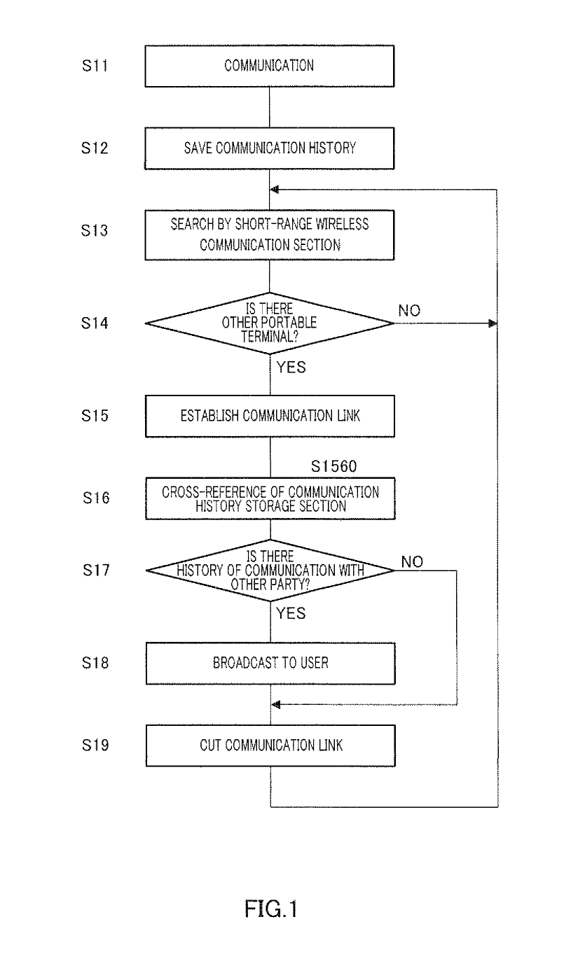

### BEST MODE FOR CARRYING OUT THE INVENTION

Now, an embodiment of the present invention will be described in detail with reference to the accompanying drawings.

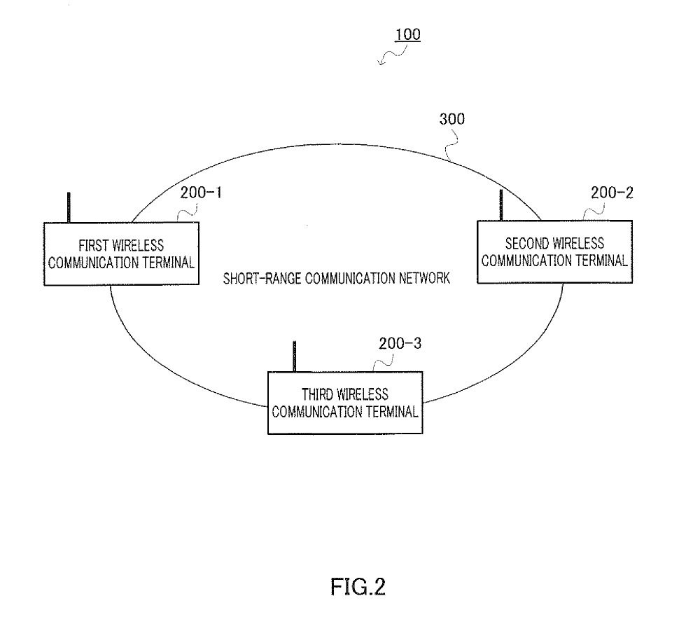

FIG. 2 is a block diagram of a communication network system having wireless communication terminals according to an embodiment of the present invention. Application examples of the present invention will be described later specifically as examples.

In FIG. 2, communication system 100 has first to third wireless communication terminals 200-1 to 200-3. First to third wireless communication terminals 200-1 to 200-3 can perform communication via short-range communication network 300. Short-range communication network 300 is a short-range wireless communication network and is constructed of a wireless communication interface such as Bluetooth (registered trademark), wireless LAN, UWB (ultra wideband), infrared rays or optical wireless. First to third wireless communication terminals 200-1 to 200-3 may have the same type of wireless communication interfaces or different types of wireless communication interfaces if the terminals can communicate with each other via a relay apparatus. However, in short-range wireless communication, it is desirable to select a wireless communication interface suitable for use in terms of communication distance and directivity.

First to third wireless communication terminals 200-1 to 200-3 have the same configuration.

Here, suppose the user of first wireless communication terminal 200-1 (hereinafter “first user”) and the user of second wireless communication terminal 200-2 (hereinafter “second user”) are acquainted with each other. The first user and second user transmit and receive e-mails or telephone conversations in the past via the Internet or a telephone communication network (neither is shown, hereinafter collectively called “public network”) using first and second wireless communication terminals 200-1 and 200-2. On the other hand, the user of third wireless communication terminal 200-3 (hereinafter “third user”) is acquainted with neither the first user nor the second user and never transmitted or received e-mails or telephone conversations to the first user or the second user in the past.

Next, the configuration of wireless communication terminal 200 according to the present invention will be described.

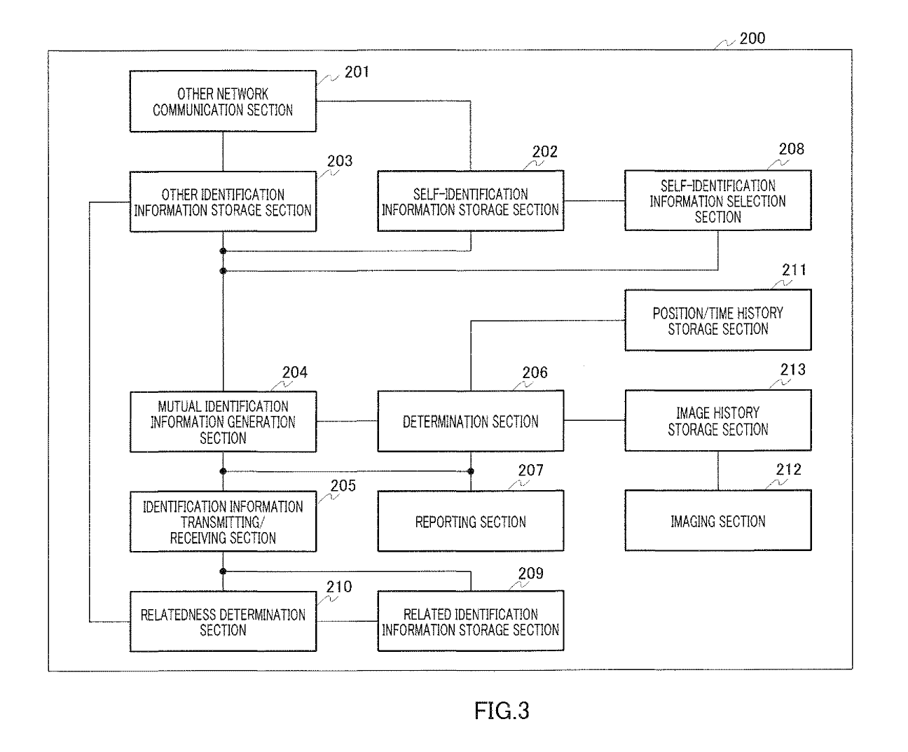

FIG. 3 is a block diagram showing the configuration of wireless communication terminal 200 according to the present embodiment.

As shown in FIG. 3, wireless communication terminal 200 includes other network communication section 201, self-identification information storage section 202, other identification information storage section 203, mutual identification information generation section 204, identification information transmitting/receiving section 205, determination section 206, reporting section 207, self-identification information selection section 208, related identification information storage section 209, relatedness determination section 210, position and time history storage section 211, imaging section 212 and image history storage section 213.

Other network communication section 201 accesses the Internet and a mobile phone network via a wireless access point and a wireless base station and perform e-mail communication and telephone communication.

Self-identification information storage section 202 stores identification information of the wireless communication terminal itself (hereinafter referred to as “self-identification information”).

Other identification information storage section 203 stores identification information of other terminals (hereinafter referred to as “other identification information”).

Self-identification information and other identification information can be set individually not only for identification information of wireless communication terminal 200 itself but also for each user who possesses a terminal. In this case, it is preferable that the self-identification information and other identification information are determined uniquely such as a telephone number, e-mail address or IP address. On the other hand, when communication is performed via a mobile phone network, there may be a case where self-identification information is mutually transmitted between two wireless communication terminals 200 and counterpart identification information can be guaranteed uniquely between these terminals. In such a case, users' names and nicknames or the like may be used as self-identification information and other identification information. That is, between terminals that try to recognize a mutual approach, self-identification information stored in one terminal may be stored as other identification information in the other terminal.

Self-identification information stored in self-identification information storage section 202 and other identification information stored other identification information storage section 203 can be set by the user or other network communication section 201.

Here, suppose in self-identification information storage section 202 of first to third wireless communication terminal 200-1 to 200-3 shown in FIG. 2, a telephone number used by other network communication section 201 in each wireless communication terminal is set as self-identification information in advance. Suppose the self-identification information of first to third wireless communication terminals 200-1 to 200-3 are “0111-11-111”, “0987-66-5555” and “011-222-3333.”

Furthermore, suppose other network communication section 201 mutually transmits a telephone number from one wireless communication terminal 200 to other wireless communication terminal 200 as self-identification information when communicating with other wireless communication terminal 200 via a public network. Then, other network communication section 201 causes other identification information storage section 203 to store the other terminal's telephone number transmitted from the other terminal as other identification information. To be more specific, other network communication section 201 creates an identification information table that shows other identification information in a list form and causes other identification information storage section 203 to store the table. This identification information table is part of, for example, a telephone book or address book used by other network communication section 201 for e-mail communication or telephone communication.

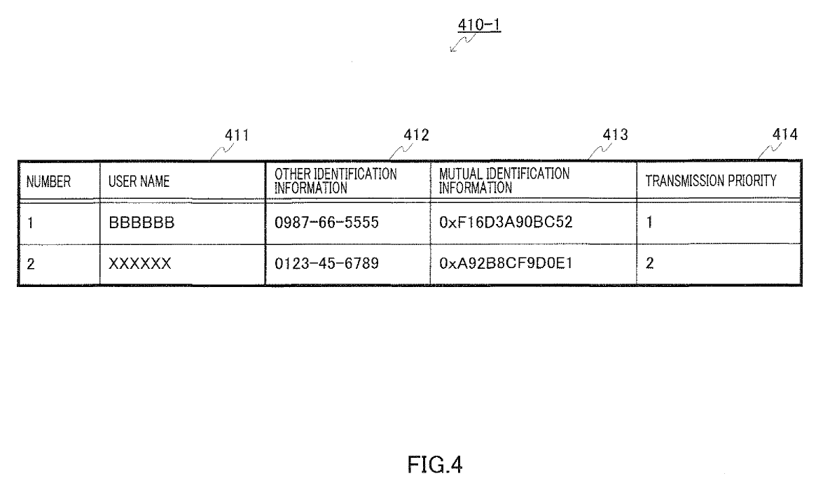

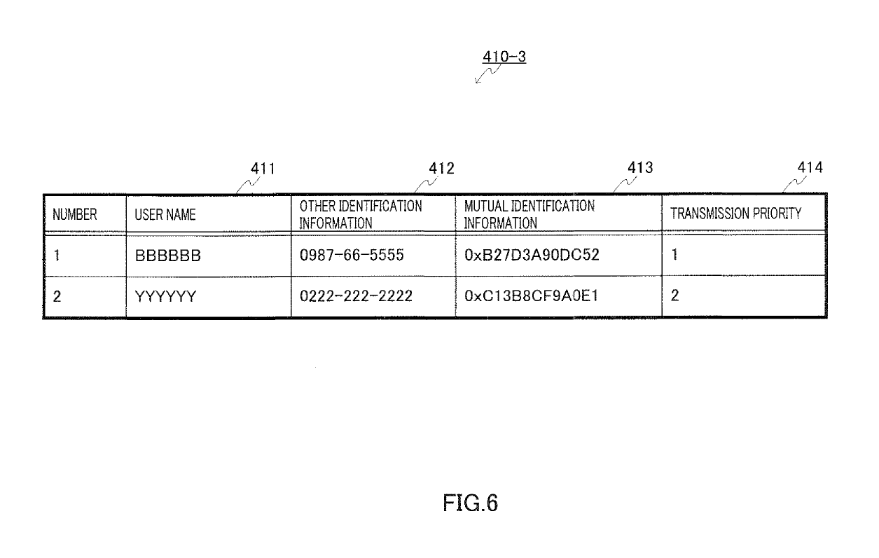

FIG. 4 to FIG. 6 show contents of identification information tables stored in other identification information storage section 203 of first to third wireless communication terminals 200-1 to 200-3.

As shown in FIG. 4 to FIG. 6, identification information table 410 is formed with user name 411, other identification information 412, mutual identification information 413 and transmission priority 414, and describes records associated with their respective numbers. User name 411 indicates user names of users of other terminals. Hereinafter, suppose users of other terminals corresponding to user names 411 of identification information table 410 are acquaintances of the user of wireless communication terminal 200 having that identification information table 410. Other identification information 412 indicates self-identification information of the other terminals possessed by the acquaintances corresponding to user names 411. Here, since telephone numbers are used as self-identification information as described above, other identification information 412 indicates telephone numbers of the other terminals possessed by the acquaintances. Mutual identification information 413 indicates mutual identification information corresponding to other identification information 412. However, character strings indicating match or mismatch of calculation results are shown here for convenience' shake instead of actual calculation results. Transmission priority 414 indicates transmission priority when mutual identification information is transmitted.

For example, identification information table 410-1 of first wireless communication terminal 200-1 describes “0987-66-5555” which is self-identification information of second wireless communication terminal 200-2 possessed by the second user as other identification information 412. Furthermore, identification information table 410-2 of second wireless communication terminal 200-2 describes “0111-11-1111” which is self-identification information of first wireless communication terminal 200-1 possessed by the first user as other identification information 412. This is because the first user and the second user are acquainted with each other.

On the other hand, none of identification information tables 410-1 and 410-2 describes “011-222-3333” which is self-identification information of third wireless communication terminal 200-3 possessed by the third user. This is because the third user is acquainted with neither the first user nor the second user. However, here, in identification information table 410-3 “0987-66-5555” which is self-identification information of second wireless communication terminal 200-3 which has been illegally acquired by the third user is registered.

Furthermore, the record of identification information table 410-1 corresponding to second wireless communication terminal 200-2 and the record of identification information table 410-2 corresponding to first wireless communication terminal 200-1 describe the same data sequence “0xF16D3A90BC52” as mutual identification information 413. This is because when the self-identification information and the other identification information are combined, the same combination result is obtained such as “0111-11-1111” and “0987-66-5555.” Mutual identification information 413 will be described later.

On the other hand, identification information table 410-3 does not describe mutual identification information 413 of the same contents as mutual identification information 413 described in identification information table 410-1. Moreover, identification information table 410-3 includes the record corresponding to second wireless communication terminal 200-2, but instead does not describe mutual identification information 413 of the same contents as mutual identification information 413 described in identification information table 410-2 after all. This is because none of identification information tables 410-1 and 410-2 describes “011-222-3333” which is the self-identification information of third wireless communication terminal 200-3. That is, this is because when self-identification information and other identification information are combined, no identical combination exists.

By comparing mutual identification information 413 of records between wireless communication terminals 200 using identification information tables 410, it is possible to determine whether or not users of wireless communication terminals 200 are acquainted with each other. That is, it is possible to recognize that an acquaintance of a user is located at a nearby position within the range of short-range communication of wireless communication terminal 200. Furthermore, it is possible to recognize who among acquaintances is approaching based on the record, mutual identification information 413 of which matches.

Every time a telephone conversation with another new party is held or every time the user performs a registration operation, other network communication section 201 in FIG. 3 creates a new record in other identification information storage section 203. By the way, mutual identification information 413 may be described in each record in advance by mutual identification information generation section 204 (described later) or may also be created by mutual identification information generation section 204 as required instead of being described in advance.

Mutual identification information generation section 204 generates mutual identification information by applying self-identification information and other identification information to a predetermined algorithm.

The predetermined algorithm used by mutual identification information generation section 204 includes a one-way function, and is commonly used by wireless communication terminals 200. As this algorithm, for example, a hash function such as MD5 (massage digest 5), SHA-1 (secure hash algorithm 1) and SHA256 (secure hash algorithm 256) or an encryption scheme such as AES (advanced encryption standard) is used. Thus, it is possible to prevent the leakage of self-identification information and other identification information used to calculate mutual identification information even if mutual identification information is disclosed to a third party.

Every time identification information transmitting/receiving section 205 (described later) receives, from another terminal, mutual identification information generated by that another terminal or every time identification information transmitting/receiving section 205 tries to perform mutual recognition on another terminal, mutual identification information generation section 204 calculates mutual identification information 413 and updates identification information table 410. To be more specific, mutual identification information generation section 204 calculates, for each record of identification information table 410, mutual identification information from other identification information 412 described in a record and self-identification information stored in self-identification information storage section 202 shown in FIG. 3 using the above described algorithm.

When mutual identification information 413 is used as a fixed value between the user and an acquaintance, mutual identification information generation section 204 may calculate mutual identification information 413 in advance. To be more specific, every time other network communication section 201 creates a new record in recognition table 410, mutual identification information generation section 204 may calculate mutual identification information for only the record and record the mutual identification information in identification information table 410.

Mutual identification information described in identification information table 410 is used by determination section 206 and relatedness determination section 210 (described later). Mutual identification information is used in two cases; a case where mutual identification information is transmitted from a terminal to another terminal to let the other terminal know an approach of the terminal and a case where mutual identification information is used for a comparison with mutual identification information received from another terminal.

In order to report the existence of the terminal to other terminals, identification information transmitting/receiving section 205 in FIG. 3 transmits one or more pieces of mutual identification information generated by mutual identification information generation section 204 to other terminals via short-range communication network 300. To be more specific, identification information transmitting/receiving section 205 transmits mutual identification information stored in an identification frame (described later). Furthermore, identification information transmitting/receiving section 205 receives mutual identification information generated by another terminal and transmitted from that another terminal via short-range communication network 300. To be more specific, identification information transmitting/receiving section 205 receives an identification frame from another terminal and acquires information stored in an identification frame as mutual identification information transmitted from the other terminal.

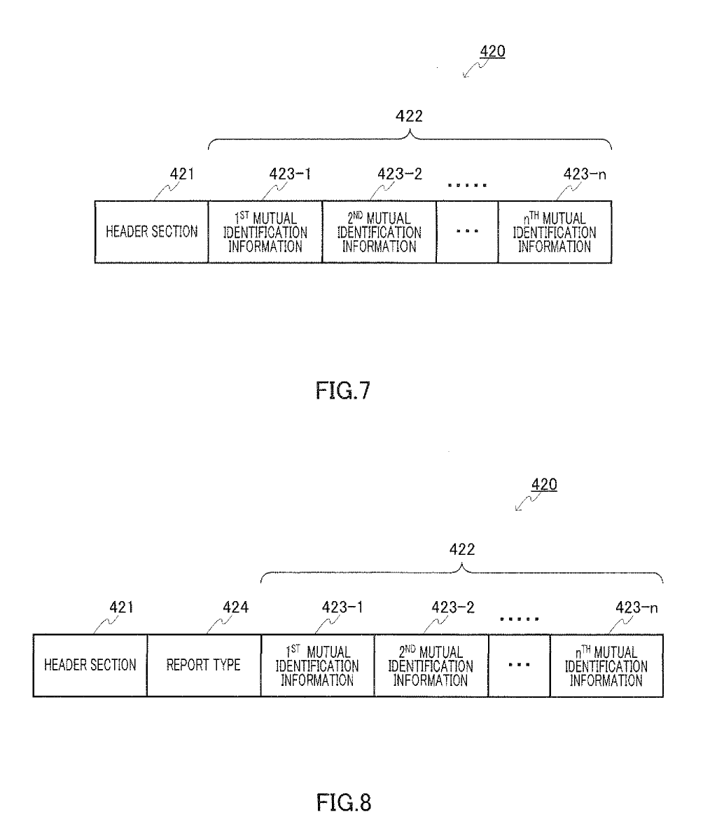

FIG. 7 shows a configuration of an identification frame transmitted by identification information transmitting/receiving section 205.

As shown in FIG. 7, identification frame 420 transmitted as an identification frame is formed with header section 421 and mutual identification information list 422.

Header section 421 indicates data of an identification frame and other information (e.g. protocol information, the number of pieces of mutual identification information, the size of one piece of mutual identification information). Furthermore, header section 421 may also store a device ID (e.g. MAC address) which is different from the identification information of wireless communication terminal 200 on the transmitting side. Such a device ID can be used for individual communication between terminals after recognition of an approach. Mutual identification information list 422 is formed with first to nth mutual identification information 423-1 to 423-n arranged in a list form.

Identification information transmitting/receiving section 205 reads mutual identification information 413 described in identification information table 410 every time the existence of the terminal should be reported to other terminals arrives.

Identification information transmitting/receiving section 205 then arranges the read mutual identification information 413 in a list form as first to nth mutual identification information 423-1 to 423-n, generates header section 421 and generates identification frame 420. After that, identification information transmitting/receiving section 205 broadcasts the generated identification frame 420 to other terminals via short-range communication network 300.

Identification frame 420 may be any frame that can be broadcast without specifying any destination terminal such as a beacon frame defined, for example, in wireless LAN or Bluetooth (registered trademark).

Furthermore, identification frame 420 may also store a report type as information for specifying a reporting method when reporting an approach of the user of wireless communication terminal 200 on the transmitting side to wireless communication terminal 200 on the receiving side to the user on the receiving side.

FIG. 8 shows a configuration of a frame that stores the report type.

When identification information transmitting/receiving section 205 specifies a reporting method for reporting the approach of the user of wireless communication terminal 200 on the transmitting side to the user on the receiving side, for wireless communication terminal 200 on the receiving side, identification information transmitting/receiving section 205 inserts a field of report type 424 in identification frame 420. Information specifying that reporting is performed in a silent mode, information specifying that reporting is performed using a report melody or the like is stored in report type 424 as the report type specifying the reporting method. Furthermore, melody data for reporting itself can also be stored in report type 424.

Furthermore, when mutual identification information 413 is transmitted, identification information transmitting/receiving section 205 in FIG. 3 preferentially transmits mutual identification information 413 of a record with higher transmission priority 414 in identification information table 410.

Although identification information tables 410-1 to 410-3 shown in FIG. 4 to FIG. 6 describe only two records respectively, actual identification information table 410 usually stores many pieces of mutual identification information 413. When many pieces of mutual identification information 413 are stored, transmitting all pieces of mutual identification information 413 included in the identification frame is not desirable from the standpoint of waste of a communication band. Moreover, communication bands available for transmission of identification frames usually have an upper limit. Therefore, transmission of mutual identification information 413 may be limited in order to reduce waste of communication bands. Even in such a case, by selecting and transmitting mutual identification information 413 of higher transmission priority 414 preferentially, it is possible to broadcast mutual identification information 413 which is common between the user and another party to be given priority such as a more familiar acquaintance.

Wireless communication terminal 200 may also dynamically change transmission priority 414 according to external information such as the current position of wireless communication terminal, current time or history of past communication with other terminals. For example, wireless communication terminal 200 may increase transmission priority 414 of business-related acquaintances during business hours or determine transmission priority 414 based on the location of acquaintances determined from telephone numbers or addresses or the like and the current position of wireless communication terminal 200. Furthermore, wireless communication terminal 200 may assume other parties with whom the user more frequently had communication as more familiar acquaintances and set corresponding transmission priority 414 to a higher value. Furthermore, to prevent continuation of a situation in which mutual identification information 413 with low transmission priority 414 is not transmitted, wireless communication terminal 200 may change contents of transmission priority 414 of identification information table 420 every certain period of time.

Determination section 206 compares mutual identification information received from another terminal and mutual identification information 413 of identification information table 410, and determines whether or not there is matching information. When there is matching mutual identification information, determination section 206 determines that the other terminal which approaches the terminal belongs to an acquaintance of the user of the terminal and determines to whom among the acquaintances the terminal belongs based on identification information table 410. On the other hand, when there is not matching mutual identification information, determination section 206 determines that the other terminal which approaches the terminal does not belong to any acquaintance of the user of the terminal.

When the approaching other terminal is determined to be wireless communication terminal 200 possessed by an acquaintance of the user of the terminal, reporting section 207 sends a predetermined report to the user. The predetermined report may be sent using one type of reporting method or using one selected from a plurality of reporting methods. For example, by setting a reporting method for each record of identification information table 410 in advance, it is possible to select a reporting method varying between acquaintances. Furthermore, it is possible to use, for example, a character display or image display using a liquid crystal display (not shown), melody output using a speaker (not shown), vibration output using a vibration element (not shown), optical output using an LED (light emitting diode) (not shown) as the reporting method.

Furthermore, when the identification frame received by identification information transmitting/receiving section 205 stores report type 424 as identification frame 420 shown in FIG. 8, reporting section 207 adopts a reporting method specified by report type 424. That is, reporting section 207 performs reporting using the reporting method set by wireless communication terminal 200 of the transmitting side of the identification frame. Therefore, conversely, wireless communication terminal 200 on the transmitting side can specify only silent vibration, that is, specify reporting in a so-called silent mode, specify reporting using a melody or specify a report melody itself for wireless communication terminal 200 on the receiving side using report type 424 of the identification frame.

When a plurality of pieces of self-identification information are stored in self-identification information storage section 202, self-identification information selection section 208 selects self-identification information to be used to generate mutual identification information transmitted to other terminals among the plurality of pieces of self-identification information.

When self-identification information for business use and self-identification information for private use are stored in self-identification information storage section 202, self-identification information selection section 208 switches between a business mode and a private mode. Self-identification information selection section 208 then causes mutual identification information generation section 204 to select and use self-identification information for business use in the business mode or self-identification information for private use in the private mode.

As a result, the mutual identification information calculated also has different contents between the business mode and the private mode. That is, mutual identification information becomes common only in a business mode with respect to other parties who recognize self-identification information for business use of the terminal in advance, that is, with respect to business-related acquaintances.

On the other hand, the mutual identification information becomes common only in a private mode with respect to other parties who recognize self-identification information for private use of the terminal in advance, that is, with respect to private acquaintances. This allows the user to avoid meeting business-related acquaintances in the private mode.

Self-identification information may be selected according to a setting by the user or may be automatically selected according to the current position of the terminal, current time or the like, or may be switched according to a control message received from another device. For example, self-identification information may be used such that self-identification information is switched to identification information for acquiring an electronic coupon according to a control message received from an access point placed in a restaurant.

Such a function of limiting approach recognition may be realized by mutual identification information generation section 204 instead of self-identification information storage section 202. In this case, mutual identification information generation section 204 further includes shared identification information shared among wireless communication terminals 200 to generate mutual identification information. When, for example, other identification information of other identification information storage section 203 is stored by being classified under categories such as “friend” and “business,” mutual identification information generation section 204 additionally uses the categories to calculate mutual identification information as shared identification information.

Even in such a case, while identification information is mutually registered, if one is classified under “friend” and the other is classified under “business,” it is possible to prevent an approach from being recognized.

When determination section 206 recognizes an approach of wireless communication terminal 200 of an acquaintance, related information storage section 209 stores mutual identification information 423 stored in an identification frame received from wireless communication terminal 200 of the acquaintance. To be more specific, related information storage section 209 acquires, as related identification information, mutual identification information other than mutual identification information corresponding to the user's terminal out of mutual identification information 423 stored in the identification frame received from wireless communication terminal 200 of the acquaintance. Related information storage section 209 then creates a related identification information table formed by associating the acquired related identification information with other identification information of wireless communication terminal 200 of the acquaintance in a list form.

Related identification information is mutual identification information stored in common between wireless communication terminal 200 of the acquaintance and wireless communication terminals 200 possessed by acquaintances of the acquaintance. Therefore, when the mutual identification information received form another terminal other than wireless communication terminal 200 of a direct acquaintance includes mutual identification information that matches related identification information acquired by the terminal, the other terminal of the transmission source of the mutual identification information belongs to an acquaintance of the acquaintance. In this case, provision of displaying a sign “acquaintance of the acquaintance” or the like enables the user to recognize an approach of the acquaintance of the acquaintance. That is, by searching mutual identification information received from another terminal in a related identification information table, it is possible to recognize the approach of an acquaintance of the acquaintance and inform the user of the approach.

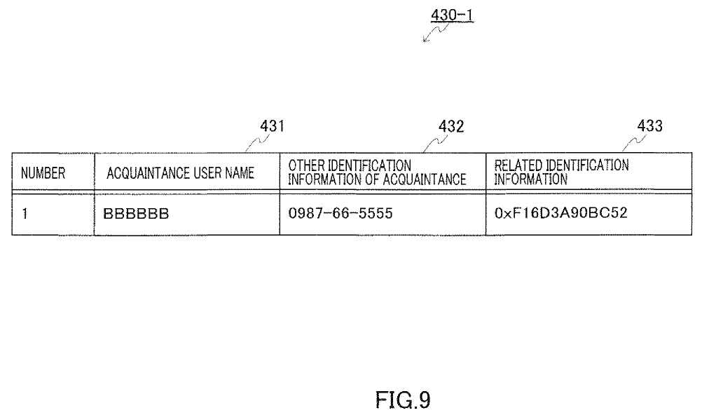

FIG. 9 shows contents of a related identification information table of first wireless communication terminal 200-1.

As shown in FIG. 9, related identification information table 430-1 of first wireless communication terminal 200-1 is formed with acquaintance user name 431, other identification information of acquaintance 432 and related identification information 433. Acquaintance user name 431 refers to user names of the users of another terminal, i.e. user names of the users of a direct acquaintance. Other identification information of acquaintance 432 refers to self-identification information of other terminals possessed by the acquaintance corresponding to user name 431. Related identification information 433 refers to related identification information acquired from other terminals indicated by other identification information 432.

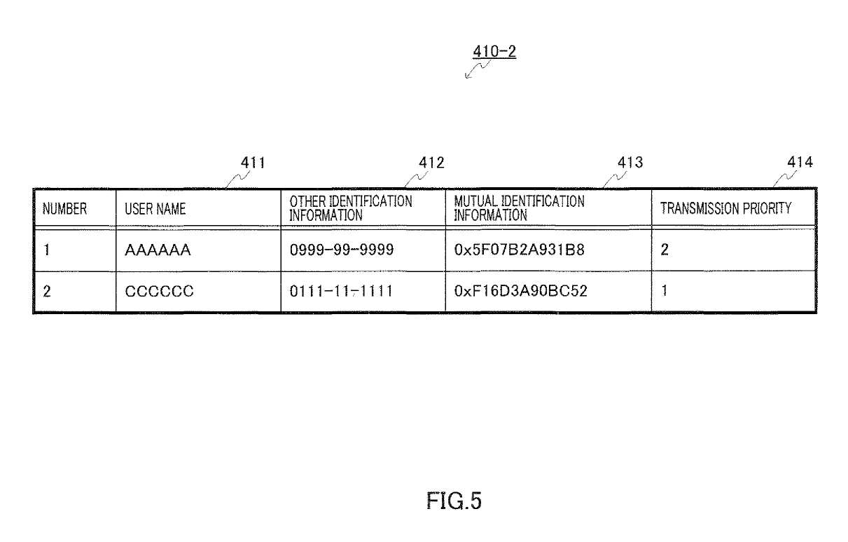

As is evident from FIG. 4 and FIG. 5, “0x5F07B2A931B8” of mutual identification information 413 described in identification information table 410-2 of second wireless communication terminal 200-2 is not described in identification information table 410-1 of first wireless communication terminal 200-1. Therefore, in this case, as shown in FIG. 9, related identification information storage section 209 of first wireless communication terminal 200-1 creates a record assuming “BBBBBB” which is the user name of second wireless communication terminal 200-2 and “0987-66-5555” which is other identification information as acquaintance user name 431 and other identification information of acquaintance 432. Related identification information storage section 209 of first wireless communication terminal 200-1 records “0x5F07B2A931B8” as acquaintance user name 431 and related identification information 433 corresponding to other identification information of acquaintance 432.

By searching acquired related identification information using related information identification information table 430-1, it is possible to recognize that an acquaintance of the user's acquaintance is approaching, and moreover identify an acquaintance of who among the user's acquaintances.

Relatedness determination section 210 in FIG. 3 determines whether or not there is matching mutual identification information received by identification information transmitting/receiving section 205 in a related identification information table of related identification information storage section 209. To be more specific, with regard to mutual identification information received by identification information transmitting/receiving section 205, when determination section 206 determines that there is not matching mutual identification information in the identification information table of other identification information storage section 203, relatedness determination section 210 searches related identification information 433 that matches the mutual identification information in the related identification information table. When there is matching mutual identification information in the related identification information table, relatedness determination section 210 recognizes that registered wireless communication terminal 200 registered in wireless communication terminal of an acquaintance whose identification information has been previously received, is approaching although identification information of the transmission source of the mutual identification information is unknown. That is, in this case, relatedness determination section 210 recognizes that an acquaintance of the user's acquaintance is approaching.

Position/time history storage section 211 acquires the current position of the terminal using other network communication section 201 or a GPS (global positioning system) section (not shown) and acquires the current time using a clock section (not shown). Furthermore, when determination section 206 determines that the approaching wireless communication terminal belongs to an acquaintance, position/time history storage section 211 stores the position of the terminal and time when determined together with the identification information of the other terminal whose approach is recognized. This allows the user to cheek “whom and when the user has met” later and display a screen for calling identification information to continue a conversation by e-mail, telephone conversation, SNS (social networking service) or the like.

Imaging section 212 has a CCD (charge coupled device), CMOS (complementary metal oxide semiconductor) or the like (none is shown) and photographs through user operation or the like. Imaging section 212 is used to photograph scenes such as a conversation with an acquaintance, surrounding landscape or the like.

Image history storage section 213 stores images photographed by imaging section 212 together with identification information of another terminal approaching the terminal when the image was picked up. In this way, it is possible to check an appearance of an acquaintance or surrounding landscape when the user met the acquaintance later or use the image of the acquaintance as an image shown upon arrival of a call or as an image for reporting when the acquaintance approaches the next time.

Furthermore, though not shown, wireless communication terminal 200 has a CPU (central processing unit), a storage medium storing a control program such as ROM (read only memory), a work memory such as RAM (random access memory) and a communication circuit. The CPU executes the control program and functions of the above described sections are thereby realized.

Next, the operation of wireless communication terminal 200 according to the present invention will be described.

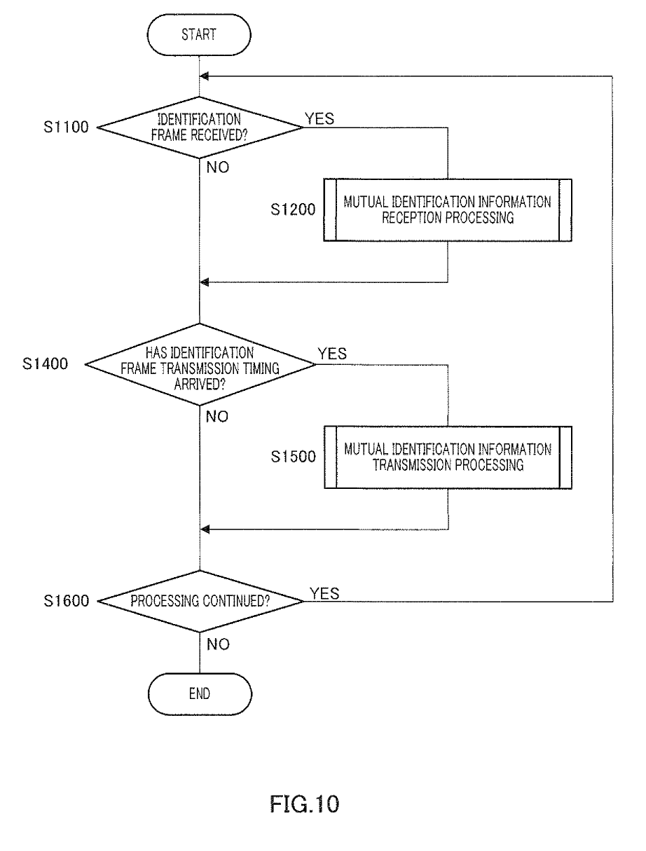

FIG. 10 is a flowchart illustrating the overall operation of wireless communication terminal 200.

First, wireless communication terminal 200 determines whether or not an identification frame has been received from another terminal (S1100) and executes mutual identification information reception processing when the identification frame has been received (S1100: “YES”) (S1200). The mutual identification information reception processing is processing for recognizing an approach of another terminal possessed by an acquaintance or an acquaintance of the acquaintance based on the received identification frame.

Wireless communication terminal 200 then determines whether or not timing at which the identification frame is transmitted from wireless communication terminal 200 has arrived (S1400) and executes mutual identification information transmission processing when the transmission timing for the identification frame has arrived (S1400: “YES”) (S1500). The mutual identification information transmission processing is processing for causing the acquaintance or an acquaintance of the acquaintance to recognize the approach of wireless communication terminal 200 through transmission of the identification frame. The timing the identification frame is transmitted may be assumed to be, for example, timing of a predetermined period or when the approach of the other terminal is detected or the like.

Wireless communication terminal 200 then determines whether or not to continue the processing (S1600), returns to step S1100 when the processing is continued (S1600: “YES”) or, on the other hand, ends a series of processing when the processing should be ended (S1600: “NO”), for example, when stoppage of the processing is instructed through user operation.

By operating in this way, wireless communication terminal 200 is able to recognize the mutual approach between the user and an acquaintance or an acquaintance of the acquaintance using an identification frame.

Next, the mutual identification information reception processing will be described in detail.

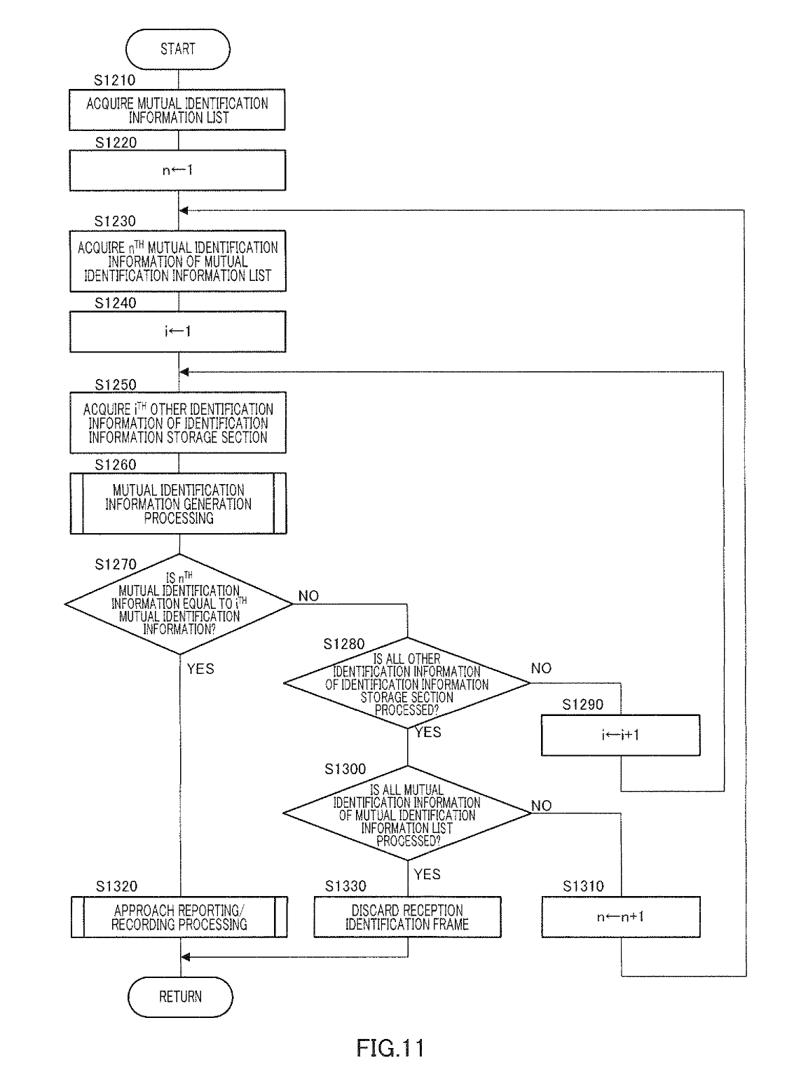

FIG. 11 is a flowchart showing mutual identification information reception processing executed by wireless communication terminal 200, which corresponds to step S1200 in FIG. 10.

First, determination section 206 acquires a mutual identification information list in the identification frame received by identification information transmitting/receiving section 205 (S1210) and assigns value “1” to variable n to perform determination processing on the mutual identification information list (S1220). Variable n indicates the position of mutual identification information in a sequence of the mutual identification information list on which processing is being performed. Determination section 206 then acquires the nth mutual identification information which is the nth mutual identification information in the mutual identification information list (S1230).

On the other hand, determination section 206 assigns value “1” to variable i to determine whether or not information corresponding to the nth mutual identification information exists in the identification information table stored in wireless communication terminal 200 (S1240). Variable i indicates that on which record in mutual identification information of the identification information table the processing is performed.

Mutual identification information generation section 204 acquires ith other identification information, which is the other identification information of the ith record of the identification information table stored in other identification information storage section 203 (S1250) and executes mutual identification information generation processing (S1260). The mutual identification information generation processing is processing for generating ith mutual identification information based on the ith other identification information.

Determination section 206 then compares the calculated ith mutual identification information with the received nth mutual identification information (S1270).

When the ith mutual identification information is not equal to the nth mutual identification information (S1270: “NO”), determination section 206 then determines whether or not processing on all the other identification information described in the identification information table of other identification information storage section 203 has been completed (S1280).

When the processing on all the other identification information of the identification information table has not been completed (S1280: “NO”), determination section 206 increments the value of variable i by 1 (S1290) and returns to step S1250. When processing on all the other identification information of the identification information table is completed as a result of repeating the processing in steps S1250 to S1290 (S1280: “YES”), determination section 206 determines whether or not the processing on all the mutual identification information described in the received mutual identification information list has been completed (S1300).

When the processing on all the mutual identification information in the mutual identification information list is not completed (S1300: “NO”), determination section 206 increments the value of variable n by 1 (S1310) and returns to step S1230.

When determination section 206 determines that the ith mutual identification information is equal to the nth mutual identification information while the processing in step S1230 to S1310 is being repeated (S1270: “YES”), wireless communication terminal 200 executes approach reporting/recording processing (S1320). The approach reporting/recording processing is processing for reporting the approach of the other terminal corresponding to the ith other identification information to the user and recording information related to the reception of the nth mutual identification information.

On the other hand, when the ith mutual identification information finally does not match the nth mutual identification information, determination section 206 discards the received identification frame (S1330) and returns to the processing in FIG. 10.

Through such processing, wireless communication terminal 200 can recognize the approach of the other terminal possessed by the acquaintance or an acquaintance of the acquaintance based on the received identification frame.

Next, the mutual identification information generation processing will be described in detail.

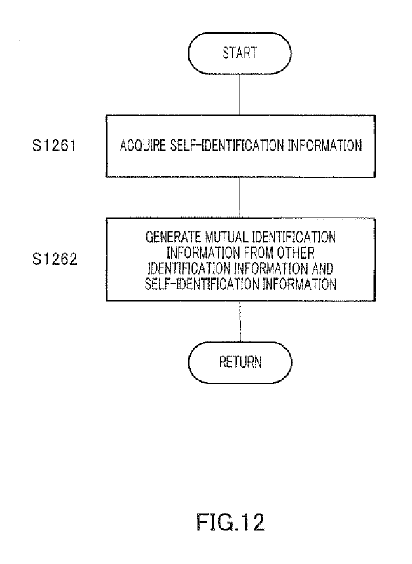

FIG. 12 is a flowchart showing mutual identification information generation processing executed by wireless communication terminal 200, which corresponds to step 1260 in FIG. 11.

First, mutual identification information generation section 204 acquires self-identification information from self-identification information storage section 202 (S1261). In this case, mutual identification information generation section 204 acquires the self-identification information selected by self-identification information selection section 208.

Mutual identification information generation section 204 generates mutual identification information (S1262) from the ith other identification information acquired in step S1250 in FIG. 11 and the self-identification information acquired in step S1260 and returns to the processing in FIG. 11.

Through such processing, wireless communication terminal 200 is able to generate ith mutual identification information based on the ith other identification information.

Next, the approach reporting/recording processing will be described in detail.

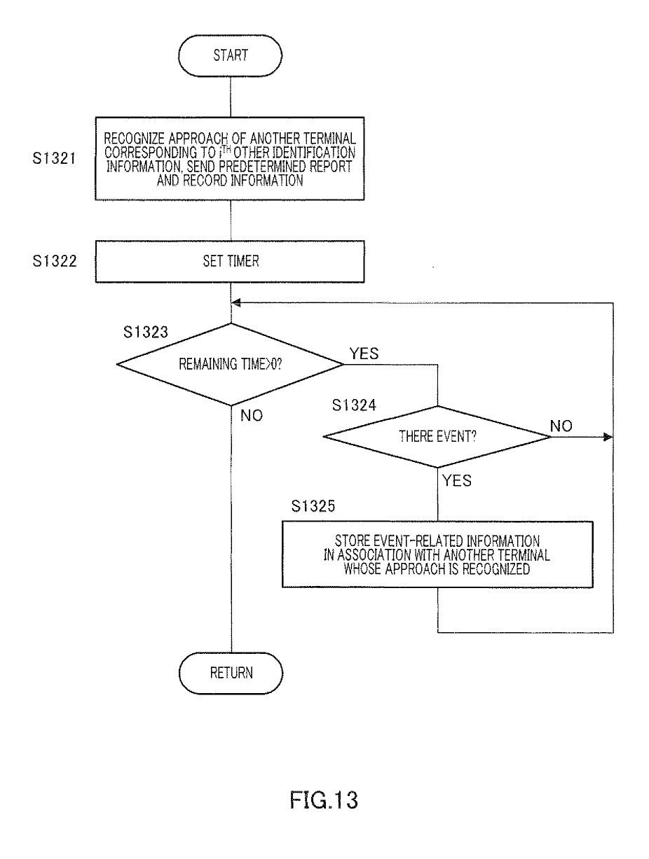

FIG. 13 is a flowchart showing approach reporting/recording processing executed by wireless communication terminal 200, which corresponds to step S1320 in FIG. 11.

First, determination section 206 recognizes an approach of another terminal corresponding to the ith other identification information, sends a predetermined report using reporting section 207 and records information on the reception of the nth mutual identification information such as the current position and current time using position/time history storage section 211.

Determination section 206 then sets a timer (not shown) to a predetermined time length, starts time counting (S1322) and determines, when the time of the timer still remains (S1323: “YES”), whether or not an event has occurred (S1324). Examples of the event include events produced through user operation such as imaging by imaging section 212, e-mail transmission and browsing of a Web page. When no event to be recorded occurs (S1324: “NO”), the process returns to step S1323.

When an event to be recorded occurs (S1324: “YES”), determination section 206 stores information related to the event that has occurred in association with the other terminal whose approach is recognized using position/time history storage section 211 and image history storage section 213 and returns to step S1323. Examples of the event-related information include the current position, current time, user name of the user of another terminal whose approach has been recognized, photographed images, acquired data and contents of user operation.

When the timer times out (S1323: “NO”) while the processing in steps S1323 to S1325 is being repeated, determination section 206 returns to the processing in FIG. 11.

Through this processing, wireless communication terminal 200 reports the approach of another terminal corresponding to the ith other identification information to the user and can record information related to the reception of the nth mutual identification information.

For example, suppose first wireless communication terminal 200-1 recognizes an approach of another terminal (Second wireless communication terminal 200-2) corresponding to other identification information of “0987-66-5555.” Furthermore, suppose the timer is set to 3 seconds and imaging section 212 performs photographing by the time the timer times out. In this case, image history storage section 213 saves the photographed image in a folder whose folder name is, for example, “0987-66-5555.” Since the identification frame is retransmitted at fixed time intervals, all images photographed while second wireless communication terminal 200-2 is approaching are saved in the folder of “0987-66-5555.” This image can be displayed when first wireless communication terminal 200-1 approaches the second user next time. Furthermore, this image can be displayed when a communication arrives from the second user via a public network. Furthermore, this image can be transmitted when an acquaintance common to the first user and the second user is approached.

Next, the mutual identification information transmission processing in FIG. 10 will be described in detail.

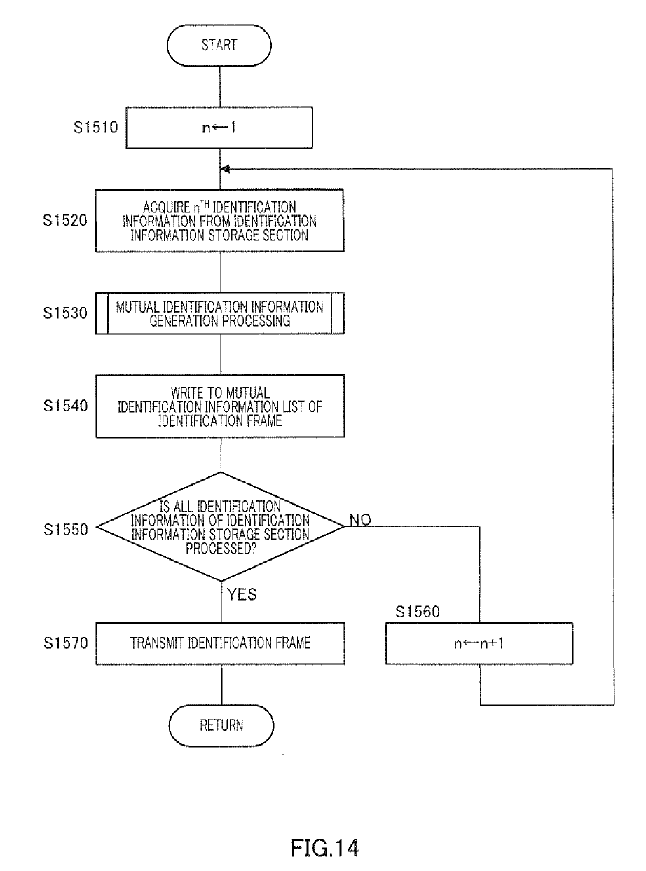

FIG. 14 is a flowchart showing mutual identification information transmission processing executed by wireless communication terminal 200, which corresponds to step S1500 in FIG. 10.

First, identification information transmitting/receiving section 205 sets value “1” in variable n (S1510) and acquires nth other identification information from other identification information storage section 203 (S1520). Identification information transmitting/receiving section 205 then performs the mutual identification information generation processing described in FIG. 12, generates nth mutual identification information (S1530) and writes the generated mutual identification information into the mutual identification information list of the identification frame (S1540).

Identification information transmitting/receiving section 205 then determines whether or not the processing on all pieces of the other identification information described in the identification information table of other identification information storage section 203 has been completed (S1550). When the processing on all pieces of the other identification information in the identification information table has not been completed (S1550: “NO”), identification information transmitting/receiving section 205 increments variable n by 1 (S1560) and returns to step S1520. As a result of repeating the processing in steps S1520 to S1560, when the processing on all pieces of the other identification information in the identification information table is completed (S1550: “YES”), identification information transmitting/receiving section 205 transmits the identification frame (S1570) and returns to the processing in FIG. 11.

Through such processing, wireless communication terminal 200 is able to transmit mutual identification information common to the user and the user's acquaintance using an identification frame. When the transmitted mutual identification information is received by the other terminal of the corresponding acquaintance, wireless communication terminal 200 can cause the other terminal to recognize the approach of wireless communication terminal 200. Furthermore, when the transmitted mutual identification information is received by another terminal having the same mutual identification information as the transmitted mutual identification information, wireless communication terminal 200 can cause the other terminal to recognize the approach of wireless communication terminal 200 as an approach of wireless communication terminal 200 of an acquaintance of the acquaintance.

When the mutual identification information is set to a fixed value as described above, identification information transmitting/receiving section 205 may calculate mutual identification information about all piece of the other identification information in advance and store the mutual identification information in other identification information storage section 203. In this case, the processing in steps S1510 to S1560 is not necessary.

Furthermore, when identification information transmitting/receiving section 205 limits the number of pieces of mutual identification information to be transmitted with reference to the transmission priority, identification information transmitting/receiving section 205 may, for example, associate variable n with the transmission priority or impose limitations to exclude the mutual identification information with low transmission priority in step S1560. Identification information transmitting/receiving section 205 may forcibly move to step S1570 within a range not exceeding a communication band available for transmission of identification information.

Thus, wireless communication terminal without disclosing private identification information to a third party.

Next, a flow of the operation of communication system 100 having wireless communication terminal 200 will be described with an example.

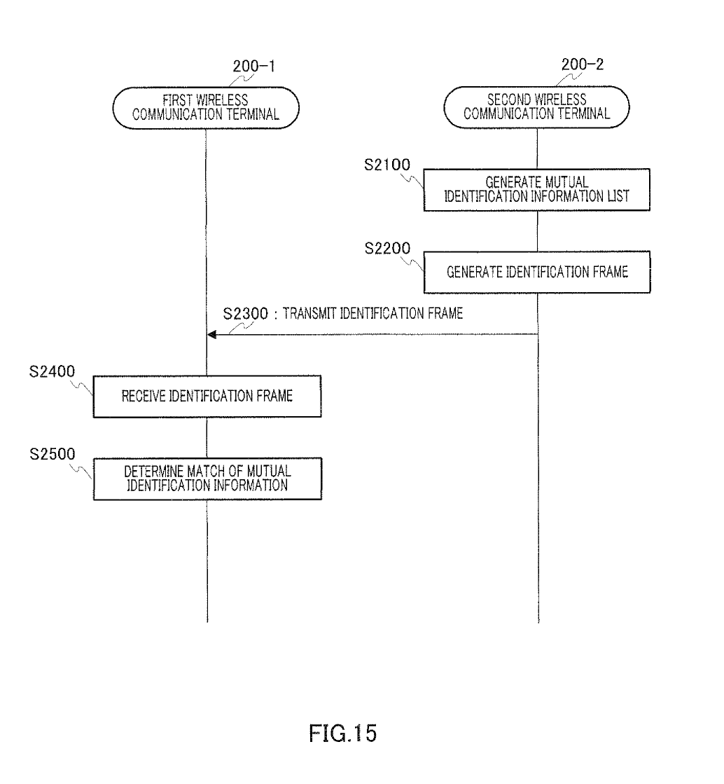

FIG. 15 shows an example of a communication sequence in communication system 100.

Suppose second wireless communication terminal 200-2 transmits an identification frame at fixed time intervals and first wireless communication terminal 200-1 is waiting to receive an identification frame from another terminal. In this case, as shown in FIG. 15, second wireless communication terminal 200-2 generates a mutual identification information list from an identification information table with which only information on other terminals such as acquaintances set by the user is registered (S2100). Second wireless communication terminal 200-2 then generates an identification frame including a mutual identification information list (S2200) and transmits the identification frame generated (S2300).

Here, suppose first wireless communication terminal 200-1 is located within a range within which it is possible to receive the identification frame of second wireless communication terminal 200-2, and first wireless communication terminal 200-1 and second wireless communication terminal 200-2 forms short-range communication network 300. In this case, first wireless communication terminal 200-1 receives the identification frame (S2400). First wireless communication terminal 200-1 then determines whether or not the mutual identification information list of the received identification frame includes mutual identification information corresponding to the other identification information of the identification information table of first wireless communication terminal 200-1 (S2500). When first wireless communication terminal 200-1 determines that there is matching mutual identification information, this means that the other terminal (second wireless communication terminal 200-2 here) of the first user's acquaintance is approaching, and therefore first wireless communication terminal 200-1 reports the approach to the first user and records the approach together with the time and position information.

As described above, according to the present embodiment, when identification information of the other terminal is stored, wireless communication terminal 200 can recognize the approach of the other terminal. Furthermore, the mutual identification information transmitted from wireless communication terminal 200, which is the other terminal in this case, cannot be recognized on the receiving side when the identification information of the transmission source is not stored in the identification information table of wireless communication terminal 200 on the receiving side. In this way, it is possible to prevent a wireless communication terminal which is not possessed by the acquaintance from recognizing the approach of the terminal. That is, it is possible to recognize the mutual approach only when the users are acquainted with each other without disclosing privacy-related information to a third party.

Furthermore, since data of a telephone book used in telephone communication can be used as other identification information used to generate mutual identification information, it is possible to recognize an approach between terminals without operations such as exchanging identification information between acquaintances in advance. That is, it is possible to recognize an approach between terminals without imposing any particular burden on the user. In addition, such an advantage can also be provided when various types of identification information used in communication via other communication networks different from short-range wireless communication such as an address book used for e-mail communication are used.

Now, more specific application examples of the above described embodiment will be described as Example 1 and Example 2. Furthermore, for convenience of explanation, a wireless communication terminal will be simply described as “terminal” below.

### Example 1

A case will be described as Example 1 of the present embodiment where the communication system shown in FIG. 2 is applied to an approach reporting system having terminals 200 carried by passengers in a train.

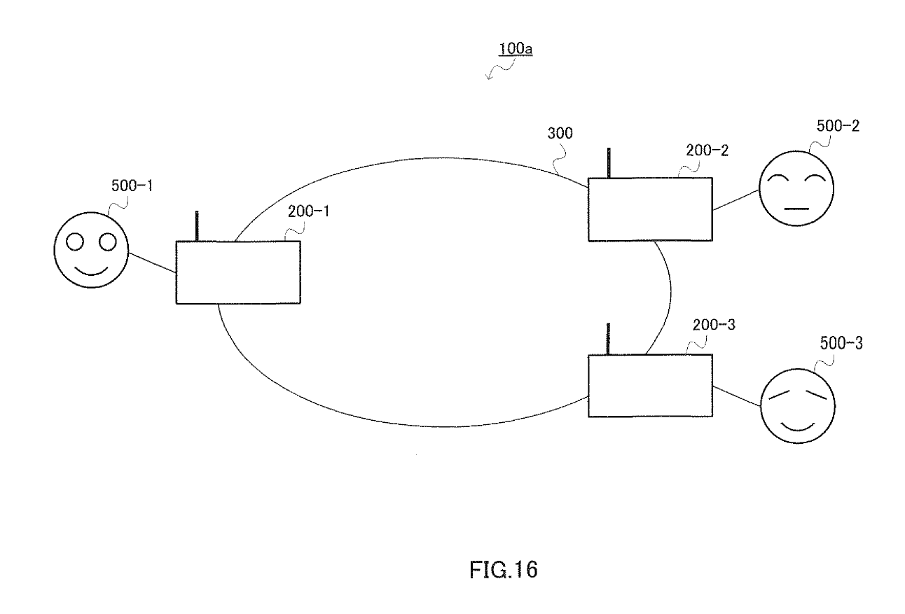

FIG. 16 illustrates a configuration of the approach reporting system according to Example 1.

In FIG. 16, approach reporting system 100a has first to third terminals 200-1 to 200-3 and short-range communication network 300. Furthermore, first to third terminals 200-1 to 200-3 are possessed by first to third users 500-1 to 500-3, respectively. However, unlike the case with communication system 100 shown in FIG. 2, suppose third user 500-3 is acquainted with second user 500-2.

When first user 500-1 carrying first terminal 200-1 rides a train, first terminal 200-1, and second and third terminals 200-2 and 200-3 of second and third users 500-2 and 500-3 who are already on the train forms short-range communication network 300.

First to third terminals 200-1 to 200-3 are transmitting/receiving identification frames through identification information transmitting/receiving section 205 of their terminals.

First user 500-1 and second user 500-2 are acquainted with each other. Therefore, identification information of second terminal 200-2 is registered with first terminal 200-1 and identification information of first terminal 200-1 is registered with second terminal 200-2. Furthermore, second user 500-2 and third user 500-3 are likewise acquainted with each other. Therefore, identification information of third terminal 200-3 is registered with second terminal 200-2 and identification information of second terminal 200-2 is registered with third terminal 200-3. Meanwhile, since first user 500-1 and third user 500-3 are not acquainted with each other, mutual identification information is not registered with first or third terminal 200-1, 200-3.

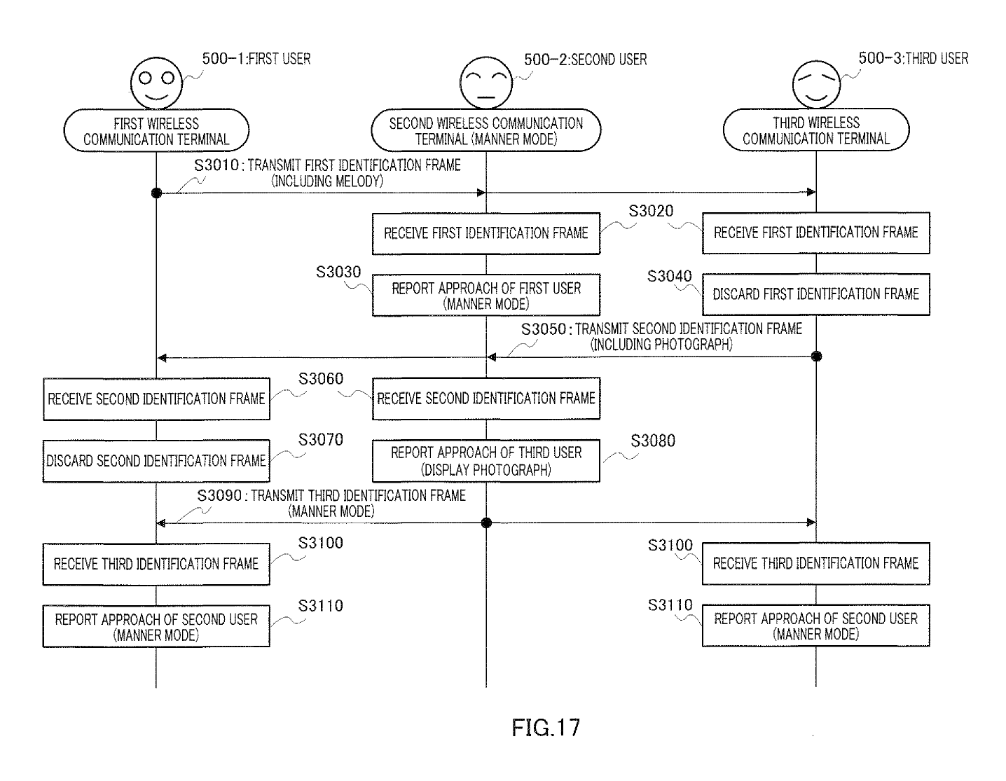

FIG. 17 is a diagram illustrating an example of a communication sequence in approach reporting system 100a shown in FIG. 16.

First, suppose first terminal 200-1 transmits a first identification frame (S3010). The first identification frame includes a mutual identification information list including mutual identification information generated by the identification information of second terminal 200-2 and melody data for reporting.

Second and third terminals 200-2 and 200-3 individually receive the first identification frame transmitted from first terminal 200-1 (S3020).

Since second terminal 200-2 registers the identification information of first terminal 200-1, second terminal 200-2 reports an approach of first user 500-1 who is the user of first terminal 200-1 (S3030). In this case, since second terminal 200-2 is set to a silent mode in which reporting is performed through vibration of the second terminal, although reporting is originally performed by playing back melody data included in the first identification frame, reporting is performed in a silent mode without outputting any sound.

On the other hand, since the identification information of first terminal 200-1 is not registered with third terminal 200-3, third terminal 200-3 discards the first identification frame (S3040).

Furthermore, suppose third terminal 200-3 transmits a second identification frame (S3050). The second identification frame includes photographic data for reporting.

First and second terminals 200-1 and 200-2 individually receive the second identification frame transmitted from third terminal 200-3 (S3060).

Since the identification information of third terminal 200-3 is not registered with first terminal 200-1, first terminal 200-1 discards the second identification frame (S3070).

Meanwhile, since second terminal 200-2 registers the identification information of third terminal 200-3, second terminal 200-2 recognizes the approach of third user 500-3 and performs reporting by displaying the photographic data included in the second identification frame and also performs reporting through vibration in a silent mode (S3080).

Finally, suppose second terminal 200-2 transmits a third identification frame (S3090). The third identification frame includes report type information specified for other terminals 200 so that reporting is performed also by other terminals 200 in the silent mode set in second terminal 200-2.

First and third terminals 200-1 and 200-3 individually receive the third identification frame transmitted from second terminal 200-2 (S3100).

Since the identification information of second terminal 200-2 is registered with both first and third terminals 200-1 and 200-3, the approach of second user 500-2 is reported in the silent mode specified in the report type in response to the reception of the third identification frame (S3110).

In this way, according to the present embodiment, each user of wireless communication terminal 200 knows only an approach of an acquaintance, reports the user's approach to only the acquaintance and does not report the user's approach to any users other than the acquaintance. Furthermore, each user of wireless communication terminal 200 is able to specify the reporting method in the other party using an identification frame. It is thereby possible to report each user's approach in an audio-visually easier way or report in a silent mode in places where producing a sound constitutes nuisance. That is, it is possible to control the way of reporting from the side whose approach is recognized to the side that recognizes the approach.

### Example 2

As Example 2 of the present invention, a case will be described where, when user 500 moves across a plurality of short-range communication networks 300, information recorded in communication system 100 shown in FIG. 2 is used for a lifelog service that records people encountered, facilities visited or the like.

Mobile phone sets are currently becoming indispensable to the lives of users. Accordingly, lifelogs are becoming a focus of attention whereby the users realize new services using histories taking advantage of mobile phone sets in their lives. Therefore, expectations are believed to be growing in the future for the realization of a new lifelog service that records a communication history in a real world among users who possess wireless communication terminals 200 such as mobile phone sets and uses the communication history for communication on a network such as e-mail and SNS.

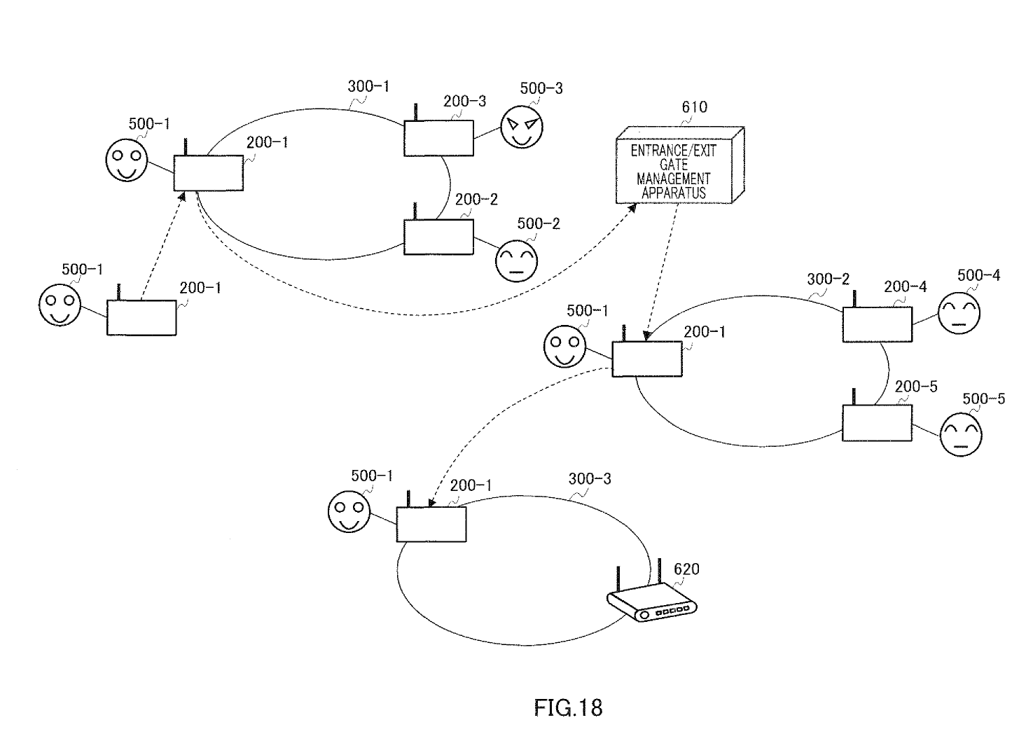

FIG. 18 illustrates a configuration of a communication system according to Example 2. This example assumes a case where first user 500-1 moves from the street corner to an office after passing through entrance/exit gate management apparatus 610 and then moves to a restaurant.

In communication system 100b in FIG. 18, as first user 500-1 moves, first to third short-range communication networks 300-1 to 300-3 are formed at different periods. First short-range communication network 300-1 is a short-range communication network configured by first to third terminals 200-1 to 200-3 approaching each other on the street corners of Shinagawa. Second short-range communication network 300-2 is a short-range communication network configured by first, fourth and fifth terminals 200-1, 200-4 and 200-5 approaching each other in an office. Third short-range communication network 300-3 is a short-range communication network configured in a restaurant by first terminal 200-1 and wireless base station 620 set up in the restaurant.

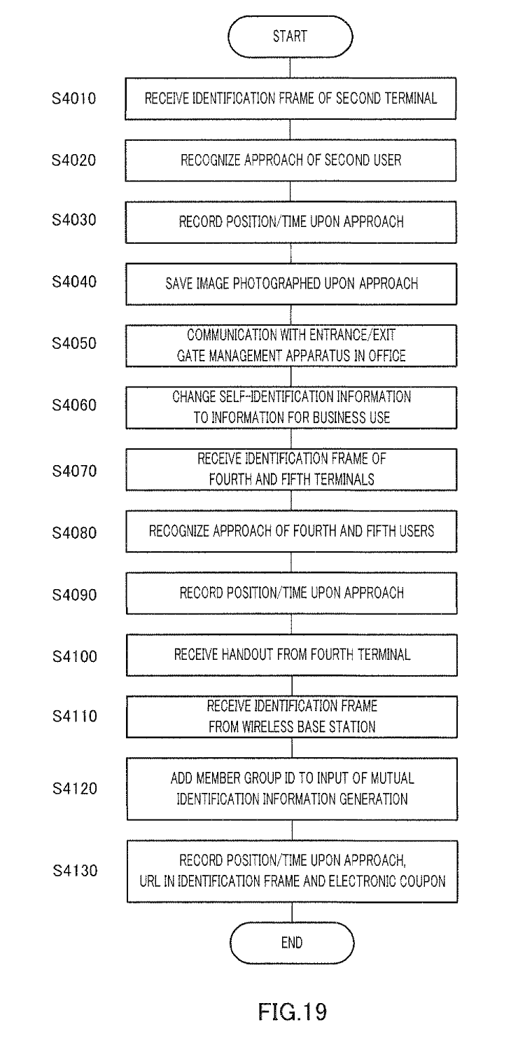

FIG. 19 is a flowchart showing an example of the operation flow of first terminal 200-1 in communication system 100b shown in FIG. 18. Though not shown in the present flowchart, suppose first terminal 200-1 periodically transmits identification frames.

Suppose first user 500-1 approaches second user 500-2 who is an acquaintance of the first user and starts a conversation on the corner of Shinagawa. In this case, first terminal 200-1 receives an identification frame of second terminal 200-2 (S4010) and recognizes an approach of second user 500-2 (S4020).

First terminal 200-1 records the position and time when second terminal 200-2 approaches (S4030). Since first terminal 200-1 periodically receives identification frames from second terminal 200-2, first terminal 200-1 performs recording assuming that first terminal 200-1 is approaching second terminal 200-2 while receiving the identification frames.

Furthermore, suppose first user 500-1 photographs an image during a conversation with second user 500-2. In this case, first terminal 200-1 saves the photographed image in association with the identification information of second terminal 200-2 (S4040).

Since first and second users 500-1 and 500-2 are engaged in conversation on the street corners of Shinagawa, suppose third user 500-3 approaches who is acquainted with neither first nor second user 500-1, 500-2. In this case, first terminal 200-1 constitutes first short-range communication network 300-1 also with third terminal 200-3 without first user 500-1 knowing it. However, since third user 500-3 is acquainted with neither first nor second user 500-1, 500-2, the identification information of first and second terminals 200-1 and 200-2 is not registered with third terminal 200-3. Furthermore, the identification information of third terminal 200-3 is registered with neither first nor second terminal 200-1, 200-2. Therefore, third terminal 200-3 cannot recognize the identification information of first and second terminals 200-1 and 200-2 transmitted from first and second terminals 200-1 and 200-2.

After that, to enter the office, suppose first user 500-1 causes first terminal 200-1 to approach entrance/exit gate management apparatus 610 at the entrance of the office. In this case, first terminal 200-1 exchanges information necessary to pass through the gate by communicating with entrance/exit gate management apparatus 610 (S4050). Through the communication with entrance/exit gate management apparatus 610, first terminal 200-1 recognizes that the terminal has entered the office and changes the self-identification information to identification information for business use (S4060). This allows first terminal 200-1 to recognize only an approach to business-related acquaintances. This function of limiting recognition can also be realized by additionally using a group ID (shared identification information) for business use to calculate mutual identification information.

After that, suppose first user 500-1 holds a meeting with fourth and fifth users 500-4 and 500-5 at a meeting room in the office. In this case, first terminal 200-1 receives identification frames from fourth and fifth terminals 200-4 and 200-5 (S4070), recognizes approaches of fourth and fifth users 200-4 and 200-5 (S4080) and records the positions and times when those users approach (S4090).

Suppose fourth user 500-4 transmits a handout from fourth terminal 200-4 during the meeting. In this case, first terminal 200-1 receives the handout (S4100) and records the received handout in association with the identification information of fourth terminal 200-4.

Finally, suppose first user 500-1 enters a restaurant. In this case, first terminal 200-1 receives an identification frame from wireless base station 620 placed in the restaurant (S4110). Suppose the identification frame transmitted from wireless base station 620 includes information indicating that the current position is a spot in the restaurant, URL (uniform resource locator) for referring to information on the restaurant, other advertisement information or the like and electronic coupons for members.

Based on the information indicating that the current position is a spot in the restaurant, first terminal 200-1 uses a member group ID for a restaurant member service to generate mutual identification information (S4120).

Suppose each terminal 200 has registered mutual identification information generated using self-identification information and a member group ID instead of self-identification information at the time of sign-up for the restaurant member service. This allows each terminal 200 to sign up the restaurant member service while protecting privacy instead of directly registering the self-identification information with the restaurant. Furthermore, when member group IDs are common to all members, each terminal 200 can generate mutual identification information registered when an acquaintance signed up. Therefore, each terminal 200 generates mutual identification information registered by an acquaintance, sets the generated mutual identification information in an identification frame, and can thereby also recognize an approach between acquaintances in the restaurant.

First terminal 200-1 records the position and time when first terminal 200-1 approached base station 620 of the restaurant and URL in the identification frame in association with the identification information of base station 620 (S4130).

Thus, first terminal 200-1 stores various events that occur in communication system 100b as first user 500-1 moves and information acquired in the events in association with wireless communication terminals 200 of acquaintances that have approached at the occurrence of the events or predetermined apparatuses or the like.

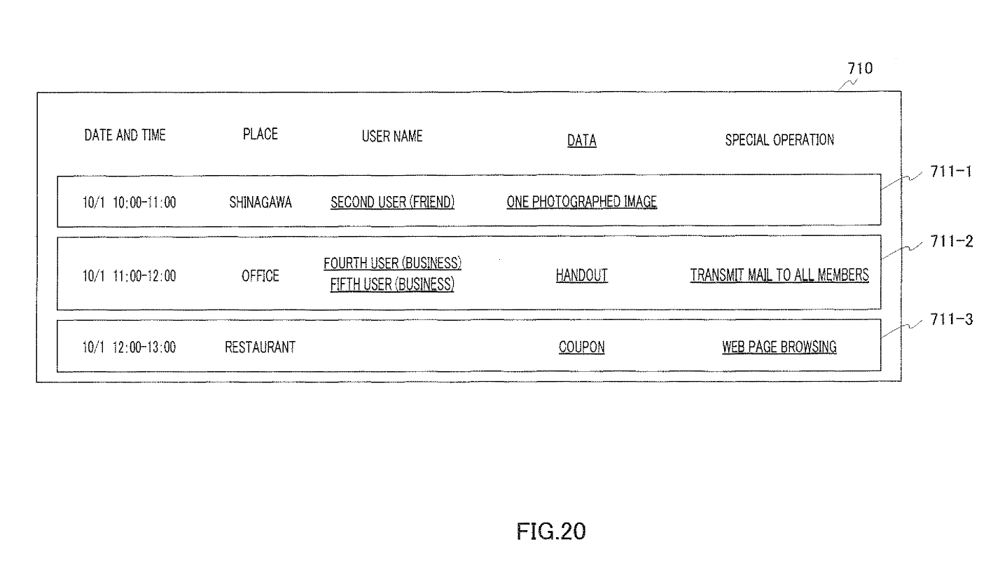

FIG. 20 illustrates an example of a lifelog display screen generated based on the information stored in first terminal 200-1 after all the sequences shown in FIG. 19 ends. To be more specific, FIG. 20 illustrates an example of the display screen when first user 500-1 handles the information stored in first terminal 200-1 as a lifelog and performs an operation of checking this lifelog. The lifelog display screen is formed on a liquid crystal display, for example, when the CPU on wireless communication terminal 200 executes a control program.

As shown in FIG. 20, lifelog display screen 710 arranges first to third history information 711-1 to 711-3 for each event that has occurred in first terminal 200-1. Each of history information 711 is formed with a place visited by first user 500-1, date and time of the visit, user name and category group of the user of terminal 200 that approached on the date and time, events that occurred during the approach, data acquired at the events (identification frame and data acquired through other communication) and available special operation.

Here, data when first user 500-1 had a conversation with second user 500-2 is displayed as first history information 711-1. When the display section of the user name is selected, lifelog display screen 710 sends an e-mail or makes a telephone call to the corresponding e-mail address or telephone number based on the identification information table. Furthermore, when “one photographed image” displayed as the acquired data is selected, lifelog display screen 710 displays or transmits by e-mail the corresponding photographed image.

Furthermore, data when first user 500-1 held a meeting with fourth and fifth users 500-4 and 500-5 is displayed as second history information 711-2. When “handout” displayed as the acquired data is selected, lifelog display screen 710 displays contents of the corresponding document. Furthermore, when “send e-mail to all members” displayed as the available special operation is selected, lifelog display screen 710 sends e-mail to all members of fourth and fifth 500-4 and 500-5 all together as destinations.

Furthermore, data when first user 500-1 dined at a restaurant is displayed as third history information 711-3. When “coupon information” displayed as the acquired data is selected, lifelog display screen 710 displays the corresponding electronic coupon information. Furthermore, when “Web page browsing” displayed as the available special operation is selected, lifelog display screen 710 displays a Web page corresponding to the electronic coupon information.

Thus, the user of wireless communication terminal 200 is able to check information on conversations with acquaintances, history of meetings, stores/restaurants visited on lifelog display screen 710 later and browse the e-mail and Web page or the like using the checked information. Furthermore, when a service that provides such lifelog display screen 710 exists on a network, the user transmits data recorded by wireless communication terminal 200 to the service provider, and can thereby cheek the above described information and use an information browsing service or the like. That is, each user of wireless communication terminal 200 can enjoy a lifelog service with excellent convenience. Furthermore, it is also possible to store history information necessary to use a lifelog service without letting unacquainted users know the user's approach.

Although, with the above described embodiment, a telephone number is the identification information of wireless communication terminal 200 used to generate mutual identification information, the present invention is not limited to this. For example, SIP URI (RFC3261) and TEL URL (RFC2806) or the like used in IMS (IP multimedia subsystem) standardized in 3GPP (3rd Generation Partnership Project) may be applicable.

Furthermore, not only identification information of wireless communication terminal 200 but also random numbers which vary every time may be added to calculations when mutual identification information is generated. To be more specific, random numbers are stored in identification frame 420, common random numbers are adopted among wireless communication terminals 200 forming one short-range communication network 300 and included in the calculation of mutual identification information. In this ease, wireless communication terminals 200 do not continuously transmit mutual identification information of the same contents. It is thereby possible to prevent a third party from keeping track of action of a specific user by using mutual identification information broadcast from wireless communication terminal 200 as a clue.

The disclosure of Japanese Patent Application No. 2007-339912, filed on Dec. 28, 2007, including the specification, drawings and abstract is incorporated herein by reference in its entirety.

### INDUSTRIAL APPLICABILITY

The wireless communication terminal and approach recognition method according to the present invention are suitable for use as a wireless communication terminal and an approach recognition method capable of recognizing a mutual approach only when users are acquainted with each other without disclosing privacy-related information to a third party. The present invention is suitable for use particularly when promoting communication in a real world by reporting an approach between users and using a history of the approach for communication on a network while protecting privacy of the users.

1. A wireless communication terminal comprising:
a self-identification information storage section that stores self-identification information comprising identification information of the wireless communication terminal;
another identification information storage section that stores other identification information comprising identification information of another terminal other than the wireless communication terminal;
a mutual identification information generation section that generates first mutual identification information from the self-identification information and the other identification information using a predetermined algorithm;
an identification information receiving section that receives by wireless second mutual identification information from the other terminal; and
a determination section that determines whether or not the first mutual identification information generated by the mutual identification information generation section and the second mutual identification information received by the identification information receiving section match.

2. The wireless communication terminal according to claim 1, wherein the self-identification information or the other identification information includes an e-mail address or telephone number.

3. The wireless communication terminal according to claim 1, wherein the determination section determines, when the first mutual identification information generated by the mutual identification information generation section and the second mutual identification information received by the identification information receiving section match, that a transmission source of the second mutual identification information is another terminal indicated by the other identification information that is a the basis of the first mutual identification information.

4. The wireless communication terminal according to claim 1, wherein:
the identification information receiving section receives the second mutual identification information through short-range wireless communication, and
the determination section determines, when the first mutual identification information generated by the mutual identification information generation section and the second mutual identification information received by the identification information receiving section match, that another terminal indicated by the other identification information that is a basis of the first mutual identification information is approaching.

5. The wireless communication terminal according to claim 1, further comprising a reporting section that sends a predetermined report to a user when the first mutual identification information generated by the mutual identification information generation section and the second mutual identification information received by the identification information receiving section match.

6. The wireless communication terminal according to claim 1, wherein the predetermined algorithm includes a one-way function.

7. The wireless communication terminal according to claim 1, further comprising a history storage section that stores, when the second mutual identification information received by the identification information receiving section and the first mutual identification information generated by the mutual identification information generation section match, information related to reception of the received second mutual identification information in association with a transmission source of the received mutual identification information.

8. The wireless communication terminal according to claim 7, wherein the information related to the reception of the second mutual identification information includes at least one of a position, time, photographed image and recorded voice.

9. The wireless communication terminal according to claim 1, wherein the self-identification information storage section stores a plurality of pieces of self-identification information,
the wireless communication terminal further comprising a self-identification information selection section that selects self-identification information to be determined by the determination section among the plurality of pieces of self-identification information stored in the self-identification information storage section.

10. The wireless communication terminal according to claim 5, wherein:
the identification information receiving section further receives reporting method specification information that specifies a method of reporting to the user from the other terminal, and
the reporting section performs the reporting using the reporting method specified by the reporting method specification information.

11. The wireless communication terminal according to claim 1, further comprising a shared identification information storage section that stores shared identification information comprising identification information shared by a plurality of terminals,
wherein the mutual identification information generation section generates the first mutual identification information from the self-identification information, the other identification information and the shared identification information using the predetermined algorithm.

12. The wireless communication terminal according to claim 1, further comprising:
a related identification information storage section that stores the second mutual identification information received by the identification information receiving section as related identification information; and
a relatedness determination section that determines whether or not third mutual identification information received by the identification information receiving section and the related identification information stored in the related identification information storage section match.

13. A wireless communication terminal comprising:
a self-identification information storage section that stores identification information of the wireless communication terminal;
another identification information storage section that stores identification information of another terminal;
a mutual identification information generation section that generates mutual identification information from the identification information of the wireless communication terminal and the identification information of the other terminal using a predetermined algorithm; and
an identification information transmitting section that transmits by wireless the mutual identification information generated by the mutual identification information generation section to the other terminal.

14. The wireless communication terminal according to claim 13, wherein the identification information includes an e-mail address or telephone number.

15. The wireless communication terminal according to claim 13, wherein the identification information transmitting section further transmits reporting method specification information that specifies a reporting method to a transmission destination of the mutual identification information when reporting the user when the transmission destination receives the mutual identification information.

16. The wireless communication terminal according to claim 13, wherein:
the self-identification information storage section stores a plurality of pieces of self-identification information, and
the identification information generation section generates the mutual identification information by making a selection from the plurality of pieces of self-identification information stored in the self-identification information storage section.

17. The wireless communication terminal according to claim 13, further comprising a shared identification information storage section that stores shared identification information comprising identification information shared by a plurality of terminals,
wherein the mutual identification information generation section generates the mutual identification information from the self-identification information, the other identification information and the shared identification information by applying the predetermined algorithm.

18. The wireless communication terminal according to claim 13, wherein:
the other identification information storage section stores a plurality of pieces of other identification information, in each of which priority is set, and
the identification information transmitting section preferentially transmits mutual identification information calculated from other identification information with higher priority.

19. The wireless communication terminal according to claim 18, further comprising a priority changing section that changes priorities according to external information, the priorities being set in a plurality of pieces of other identification information stored in the other identification information storage section.

20. The wireless communication terminal according to claim 19, wherein the external information comprises at least one of a current position of the wireless communication terminal, current time and past history of communication with other parties corresponding to the plurality of pieces of other identification information.

21. A wireless communication terminal comprising:
a self-identification information storage section that stores self-identification information comprising identification information of the wireless communication terminal;
another identification information storage section that stores other identification information comprising identification information of another terminal other than the wireless communication terminal;
a mutual identification information generation section that generates first mutual identification information from the self-identification information and the other identification information using a predetermined algorithm;
an identification information transmitting/receiving section that receives by wireless second mutual identification information from the other terminal and transmits by wireless the first mutual identification information generated by the mutual identification information generation section to the other terminal; and
a determination section that determines whether or not the first mutual identification information generated by the mutual identification information generation section and the second mutual identification information received by the identification information transmitting/receiving section match.

22. A terminal recognizing method comprising the steps of:
generating first mutual identification information from own terminal identification information comprising identification information of a terminal and other identification information comprising identification information of another terminal other than the terminal using a predetermined algorithm;
storing the first mutual identification information generated in a storage means;
receiving by wireless second mutual identification information from the other terminal;
searching in the storage means the first mutual identification information that matches the received second mutual identification information; and
a step of determining, when the first mutual identification information that matches the received second mutual identification information exists in the storage means, that a transmission source of the second mutual identification information is the other terminal indicated by the other identification information that is a basis of the first mutual identification information.

23. A terminal recognizing method comprising the steps of:
receiving by wireless first mutual identification information from another terminal other than a terminal;
generating second mutual identification information from own terminal identification information comprising identification information of the terminal and other identification information comprising identification information of the other terminal using a predetermined algorithm;
determining whether or not the received first mutual identification information and the generated second mutual identification information match; and
determining, when the received first mutual identification information and the generated second mutual identification information match, that a transmission source of the first mutual identification information is the other terminal indicated by the other identification information that is a basis of the second mutual identification information.
